(19) United States
(12) Patent Application Publication
(10) Pub. No.: US 2009/0063566 A1
(43) Pub. Date: Mar. 5, 2009

(54) PARTY RESERVATION SUPPORT SYSTEM

(75) Inventors: Isao Ikezawa, Tokyo (JP); Ryoko Aoyagi, Tokyo (JP)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: GOURMET NAVIGATOR INCORPORATED, Tokyo (JP)

(21) Appl. No.: 11/911,467

(22) PCT Filed: Apr. 18, 2006
(86) PCT No.: PCT/JP2006/308121

§ 371 Date: Oct. 12, 2007

(30) Foreign Application Priority Data
Apr. 20, 2005 (JP) 2005-121903
Sep. 28, 2005 (JP) 2005-281091

(51) Int. Cl. G06F 17/30

(52) U.S. Cl. 707/104.1; 707/E17.009

(57) ABSTRACT

It is possible to provide a party reservation support system enabling an organizer of a party to consult with participants about eating and drinking establishments and date and make a reservation for a particular eating and drinking establishment at a particular date. The party reservation support system includes: eating and drinking establishment information storage means; party information storage means; participant information storage means; eating and drinking establishment information search means for searching eating and drinking establishments and transmitting the result to an organizer terminal; party information storage means for storing information on candidates of the eating and drinking establishment and the date; to-participant transmission means for transmitting an e-mail on the eating and drinking establishment and the date candidates to participants; totaling means for receiving and adding the information on the party date selected by the participants and objective evaluations on the eating and drinking establishment candidates; first reservation means for transmitting and e-mail for party reservation to the eating and drinking establishment decided by the organizer after the deadline of the response; and decision transmission means for transmitting information on the decided date and eating and drinking establishment to the participants.

### TECHNICAL FIELD

The present invention relates to a party reservation support system which makes it possible for an organizer to make reservations regarding the eating and drinking establishment, the date and time, and the like while conferring with other participants regarding the eating and drinking establishment, date and time, and the like in cases in which a party is to be held.

### BACKGROUND ART

It is often the case that a plurality of persons gathers and holds a party, as in year's end parties, New Year's parties, send-off parties, company parties, and the like. In the case of such parties, an organizer is determined, and this organizer sets the eating and drinking establishment, date, and time, and communicates with the other participants.

In recent years, as a result of the development of the Internet, it has become possible to obtain information regarding eating and drinking establishments, which are the main meeting places for parties, via a network, accordingly, as is described in the following Patent Document 1, there is an invention in which handling of the party is accomplished as follows: first, the organizer determines the schedule by receiving candidates with a convenient schedule from the respective participants; then, the organizer similarly determines the eating and drinking establishment by receiving eating and drinking establishments, genres of cuisine, or the like from the respective participants.

Patent Document 1: Japanese Laid-open Patent Application No. 2003-58665

### DISCLOSURE OF THE INVENTION

### Problems to be Solved by the Invention

However, in the case described in the abovementioned Patent Document 1, in regard to the eating and drinking establishment that is selected, a desirable eating and drinking establishment is merely selected from eating and drinking establishments chosen by the organizer, and is transmitted, accordingly, the organizer does not actually know how suited the eating and drinking establishment selected by the participants is to the tastes of the participants. In other words, there are differences, i.e., the eating and drinking establishment may have been selected on the basis of an extremely good impression, or it may be the case that there was no good impression among previously selected eating and drinking establishments, but since a choice had to be made, a selection was made from eating and drinking establishments that were the least objectionable among the candidates. Accordingly, it is not necessarily the case that an eating and drinking establishment will be accepted by the party participants on the grounds that it was decided to hold the party at an eating and drinking establishment most widely selected by the participants.

Furthermore, since the respective participants select their respective desired schedules from a calendar, and transmit these schedules to the organizer as requests, there is a possibility that the situation will get out of control, especially in cases in which the number of participants is large. In other words, since the participants merely report schedules that are convenient for themselves, it is extremely difficult for the organizer to combine these schedules into a single schedule.

Furthermore, the organizer informs the respective participants of the name and address of the eating and drinking establishment that is the location of the party, the schedule of the party, and the like; however, since this information does not extend to a map, the participants must investigate the location of the eating and drinking establishment themselves on the basis of the address or the like.

### Means Used to Solve the Above-Mentioned Problems

In light of these various problems, the present inventors devised the party reservation support system described below.

A first aspect of the present invention is a party reservation support system comprising: eating and drinking establishment information storage means for storing information relating to eating and drinking establishments; party information storage means for storing information relating to candidate dates and times for the party, and information relating to candidate eating and drinking establishments for holding the party; participant information storage means for storing attribute information for the party participants; eating and drinking establishment information search means for receiving search conditions for said eating and drinking establishments from an organizer terminal used by the party organizer, retrieving information relating to eating and drinking establishments that satisfy said search conditions from said eating and drinking establishment information storage means, and transmitting to said organizer terminal; party information registration means for receiving, from said organizer terminal, instructions for registering eating and drinking establishments selected from the eating and drinking establishments found by said search as candidates, and information relating to candidate dates and times for said party designating said selected eating and drinking establishments as candidate eating and drinking establishments for said party, and storing said candidate eating and drinking establishments and candidate dates and times in said party information storage means; to-participant transmission means for retrieving the email addresses of participants designated as participants in said party from said participant information storage means, and transmitting an email, to said retrieved email addresses, describing said candidate, for the party, eating and drinking establishments and said candidate dates and times; totaling means for receiving information relating to the party dates and times selected by said participants and information relating to objective evaluations for said candidate eating and drinking establishments as responses to said organizer from participant terminals used by said participants, and adding this information to the number of persons approving the candidate dates and times for said party in said party information storage means, and the objective evaluations for said eating and drinking establishments; first reservation means for receiving information, from said organizer terminal, relating to the date, time, and eating and drinking establishment at which the party is to be held as decided by said organizer, after said responses have been cut off, retrieving the email address of the eating and drinking establishment that has been decided upon from said eating and drinking establishment information storage means, and transmitting an email making reservations for said party to said retrieved email address of the eating and drinking establishment; and decision transmitting means for retrieving the email addresses of said party participants from said participant information storage means, and transmitting information relating to the date, time, and eating and drinking establishment decided for said party to said retrieved email addresses.

A second aspect of the present invention is a party reservation support system comprising: eating and drinking establishment information storage means for storing information relating to eating and drinking establishments; party information storage means for storing information relating to candidate dates and times for holding a party, and information relating to candidate eating and drinking establishments at which the party may be held; participant information storage means for storing attribute information relating to the party participants; eating and drinking establishment information search means for receiving search conditions for said eating and drinking establishments from an organizer terminal used by said party organizer, retrieving information relating to eating and drinking establishments that satisfy said search conditions from said eating and drinking establishment information storage means, and transmitting this information to said organizer terminal; party information registration means for, from said organizer terminal, receiving instructions for registering eating and drinking establishments, as candidates, selected from the eating and drinking establishments found by said search, and information relating to candidate dates and times for said party designating said selected eating and drinking establishments as candidate eating and drinking establishments for said party, and storing said candidate eating and drinking establishments and candidate dates and times in said party information storage means; to-participant transmission means for retrieving, from said participant information storage means, the email addresses of participants designated as participants in said party, and transmitting, to said retrieved email addresses, an email describing said candidate eating and drinking establishments for the party and said candidate dates and times; totaling means for receiving, from participant terminals used by said participants, as responses to said organizer, information relating to the dates and times of the party selected by said participants and information relating to objective evaluations for said candidate eating and drinking establishments, and adding this information, respectively, to the number of persons approving the candidate dates and times for said party and to the objective evaluations for said eating and drinking establishments in said party information storage means; second reservation means for receiving, from said organizer terminal, information relating to the date and time of the party and the eating and drinking establishment decided by said organizer after stopping acceptance of said responses, and transmitting, to the email address of a predetermined contact person, an email making reservations for said party; and decision transmitting means for retrieving, from said participant information storage means, the email addresses of said party participants, and transmitting, to said retrieved email addresses, information relating to the date, time, and eating and drinking establishment that have been decided upon for the party.

As a result of the use of configurations such as those described in the first and second aspects of the present invention, it is possible for the party participants to transmit positive feelings or negative feelings relating to the selected eating and drinking establishment, that is, the extent of the desirability of the eating and drinking establishment, rather than a statement indicating which eating and drinking establishment is desirable, to the organizer. As a result, the organizer can judge to some extent whether the participants selected a candidate eating and drinking establishment because of an actual liking for this eating and drinking establishment, or whether a selection was made on the basis of negative feelings, i.e., because no other choice was available, and this eating and drinking establishment was the least objectionable among the candidates. In cases in which the organizer receives the impression that negative feelings are prevalent, the organizer can also re-select other eating and drinking establishments as candidates. Accordingly, the party becomes more acceptable to the participants.

In regard to reservations, furthermore, the organizer may make reservations directly with the eating and drinking establishment as described in the first aspect, or may use a contact person as described in the second aspect. In cases in which a contact person is used, the burden on the organizer is reduced.

A third aspect of the present invention is a party reservation support system according to claim 1 or 2, characterized in that said totaling means transmits intermediate processes and/or results of said responses in a graph format to said organizer terminal and said participant terminals.

By thus graphing the responses from the participants with respect to the candidates, it is possible to facilitate visual recognition.

A fourth aspect of the present invention is a party reservation support system according to any of claims 1 through 3, characterized in that said party reservation support system further has map information storage means for storing map information relating to the vicinity of said eating and drinking establishments, and said decision transmitting means attaches and transmits the map information relating to the vicinity of the eating and drinking establishments to the email addresses used for transmissions to said participants.

Furthermore, in cases in which the eating and drinking establishment at which the party will be held has been determined, the participants can easily grasp the location of this eating and drinking establishment as a result of a map of the area around the eating and drinking establishment being appended as in the present invention. Conventionally, the participants themselves have searched for and obtained a map on the basis of the address, but the burden of this search is eliminated in this invention.

A fifth aspect of the present invention is a party reservation support system according to any of claims 1 through 4, characterized in that said participant information storage means further stores a plurality of participants as one group, and when said group is selected as participants, said to-participant transmission means and said decision transmitting means retrieve, from said participant information storage means, the email addresses of participants belonging to said group, and transmit emails.

The system may be devised so that a group can be selected as participants rather than selecting individual participants. In cases in which a group is designated as participants, the burden of selecting individual participants is lessened. Furthermore, if a group is selected, the persons belonging to this group automatically become participants, emails are transmitted, and the burden is therefore greatly reduced.

A sixth aspect of the present invention is a party reservation support system according to any of claims 2 through 5, characterized in that said party reservation support system further comprises first reservation means for receiving, from said organizer terminal, information relating to the party date, time, and eating and drinking establishment decided by said organizer after stopping acceptance of said responses, retrieving, from said eating and drinking establishment information storage means, the email address of said determined eating and drinking establishment, and transmitting, to said retrieved email address of the eating and drinking establishment, an email making reservations, wherein

a screen for selecting a method by which reservations are made, the method including said first reservation means and said second reservation means, is transmitted to said organizer terminal, and the selection results are received from said organizer terminal, whereby said email for making reservations for the party is transmitted by the first reservation means or second reservation means using the selected reservation method.

In this aspect of the present invention, the organizer can elect to make reservations itself directly with the eating and drinking establishment, or to rely on a contact person to make reservations.

A seventh aspect of the present invention is a party reservation support system according to claim 1, characterized in that said first reservation means, when information relating to the date and time of the party decided by said organizer is received from said organizer terminal, designates as attendees those participants who have selected said decided date and time, designates as absentees those participants who have selected a date and time other than the decided date and time are designated, and stores in said party information reservation means, and transmits, when it transmits an email making reservations for said party is transmitted to the email address of said eating and drinking establishment that has been decided upon, an email in which said number of persons designated as attendees is described as the number of participants to the same.

An eighth aspect of the present invention is party reservation support system according to claim 2, characterized in that said second reservation means, when information relating to the date and time of the party decided by said organizer is received from said organizer terminal, designates as attendees the participants who have selected said decided date and time, designates as absentees those participants who have selected a date and time other than the decided date and time, and stores in said party information reservation means, and transmits, when it transmits an email making reservations for said party to the email address of said contact person, an email in which said number of persons designated as attendees is described as the number of participants to the same.

In these aspects of the present invention, participants whose schedules show no conflict can automatically be set as attendees; accordingly, there is no need for the organizer to count up the number of participants. Especially in the case of a large party, counting the number of participants is a sizeable task; accordingly, this can be accurately accomplished.

A ninth aspect of the present invention is a party reservation support system according to claim 1 or 2, characterized in that said party reservation support system further comprises reminding means for transmitting, when said totaling means does not receive, after a specified time has elapsed, a response to the email transmitted to the email addresses of the respective participants by said to-participant transmission means, an email urging said participants, from whom no response has been received, to respond.

If no response to the party is received, the organizer likewise cannot confirm the number of participants and the like, and cannot ascertain the evaluation of the eating and drinking establishment and the like; accordingly, the organizer is greatly inconvenienced. A response can therefore be urged by transmitting a reminder email to persons who have not sent any answer even though a specified time (or number of days) has elapsed.

### EFFECT OF THE INVENTION

In the present invention, in regard to eating and drinking establishments, it is possible to obtain not only a statement to the effect that “this eating and drinking establishment is good,” as in a conventional system, but also an objective evaluation indicating that “the impression of this eating and drinking establishment may be graded by the following score.” Accordingly, the organizer is able to grasp whether the participants are making a positive selection, or are merely making a selection because of a lack of alternatives (negative selection). Consequently, even with an eating and drinking establishment most widely selected by the participants, the organizer can judge that this eating and drinking establishment was merely selected in a negative manner if the objective evaluation is low, and can propose other eating and drinking establishments as candidates.

Furthermore, since a configuration is used in which selected candidate dates and times are transmitted beforehand, and the participants make a choice from these candidates, there is an increased tendency for the participants to judge the date and time on the criterion of “a date that is not inconvenient” rather than a “date that is convenient” for themselves, and to transmit to the organizer. As a result, management of the data and time by the organizer is also facilitated.

Furthermore, when the plan for a party has been decided, notification with a map attached can be transmitted to the participants by the organizer; this improves the convenience for the participants.

### BRIEF DESCRIPTION OF THE DRAWINGS

FIG. 1 is a system configuration diagram showing one example of the system configuration of the present invention;

FIG. 2 is a flowchart showing one example of the process of the present invention;

FIG. 3 shows one example of a screen used to search for eating and drinking establishments constituting candidates for the party;

FIG. 4 shows one example of an email containing party information that is transmitted to the respective participants;

FIG. 5 shows one example of a screen for displaying responses to a discussion of the party;

FIG. 6 shows one example of a screen for making party reservations;

FIG. 7 shows one example of an email containing party information that has been decided, which is transmitted to the respective participants; and

FIG. 8 shows another example of a screen for displaying responses to a discussion of the party.

### DESCRIPTION OF THE NUMERICAL SYMBOLS

1: Party reservation support system
2: Organizer terminal
3: Eating and drinking establishment information search means
4: Eating and drinking establishment information storage means
5: Party information registration means
6: Party information storage means
7: Participant information storage means
8: To-participant transmission means
9: Totaling means
10: First reservation means
11: Second reservation means
12: Decision transmitting means
13: Map information storage means
14: Participant terminal
15: Network

### BEST MODE FOR CARRYING OUT THE INVENTION

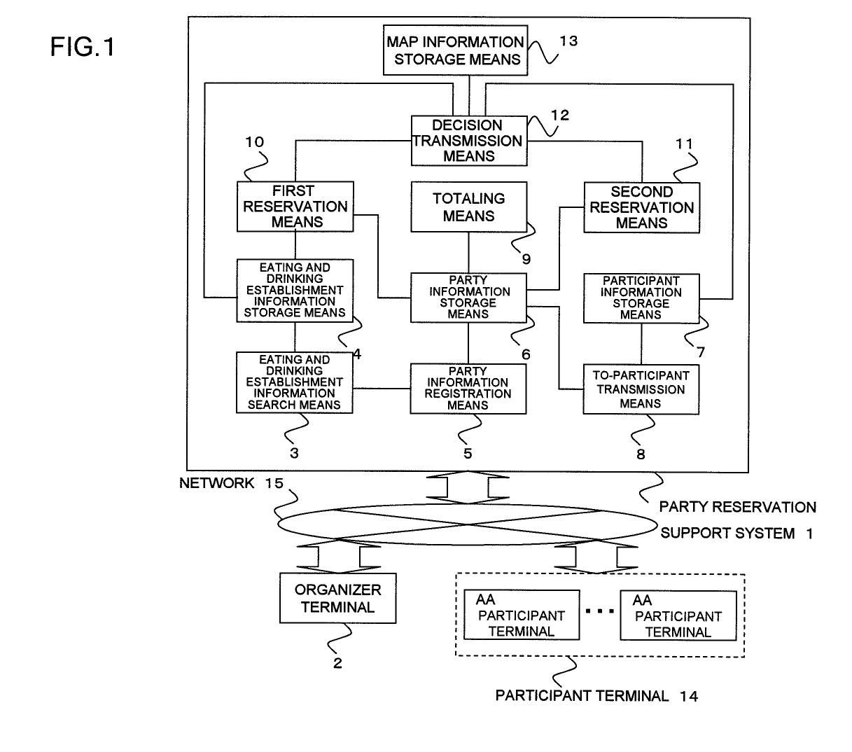

One example of the system configuration of the party reservation support system 1 of the present invention will be described with reference to the system configuration diagram shown in FIG. 1. The party reservation support system 1 can send and receive data between computer terminals (participant terminals 14) used by the party participants and a computer terminal (organizer terminal 2) used by the party organizer via a network 15 such as the Internet or the like.

The processing of the party reservation support system 1 of the present invention is realized on a computer terminal (including a server as well) which has an arithmetic processing device such as a CPU or the like, and a storage device such as a RAM, hard disk, and the like. The program that is used to realize the party reservation support system is recorded on the hard disk of this computer terminal, and is read into the RAM or the like by performing a specified operation, and the functions (means) are executed by the arithmetic processing device, so that processing is performed. Furthermore, the information stored as the storage means used in this processing is stored in RAM, hard disk, or the like in various file saving formats such as databases, data files, or the like, and is appropriately retrieved at the time of processing, whereby processing is performed. Moreover, the results of processing are also written into a storage device such as a RAM, hard disk, or the like, and are appropriately stored.

The party reservation support system 1 has eating and drinking establishment information search means 3, eating and drinking establishment information storage means 4, party information registration means 5, party information storage means 6, participant information storage means 7, to-participant transmission means 8, totaling means 9, first reservation means 10, second reservation means 11, decision transmission means 12, and map information storage means 13.

The eating and drinking establishment information search means 3 is a means that performs a search in the eating and drinking establishment information storage means 4 by receiving information relating to candidate eating and drinking establishments from the organizer terminal 2 in order to select the eating and drinking establishment at which the party will be held.

The eating and drinking establishment information storage means 4 stores information relating to eating and drinking establishments, and stores identifying information such as the names of eating and drinking establishment and the like, and various types of information such as addresses, telephone numbers, email addresses, areas, business types, menus, and the like.

The party information registration means 5 is a means for receiving from the organizer terminal 2 candidate dates and times for holding the party, candidate eating and drinking establishments found by the eating and drinking establishment information search means 3, the decided date and time of the party, and various types of other information relating to the eating and drinking establishment, and stores this information in the party information storage means 6.

The party information storage means 6 is a means for storing candidate dates and times for holding the party, candidate eating and drinking establishments found by the eating and drinking establishment information search means 3, the decided date and time of the party, and various types of other information relating to the eating and drinking establishment received from the organizer terminal 2 by the party information registration means 5.

The participant information storage means 7 is a means for storing attribute information such as names, email addresses, and the like of the organizer and participants, and is preferably a means whereby participants store personal attribute information of the organizer and participants, as in an address book.

The to-participant transmission means 8 is a means which transmits a notification of candidate dates and times for holding the party and candidate eating and drinking establishments found by the eating and drinking establishment information search means 3, which are stored by the party organizer in the party information storage means 6, to the email addresses of the participants stored in the participant information storage means 7.

The totaling means 9 is a means for receiving information selected from the candidates by the respective participants on the basis of the content of the notification made to the respective participants by the party organizer using the to-participant transmission means 8, and stores this information in the party information storage means 6. For example, this means receives the dates and times that have been selected by the participants, as well as evaluations of candidate eating and drinking establishments, and stores this information in the party information storage means 6.

The first reservation means 10 is a means whereby the organizer, who has inspected the totaled responses from the respective participants after the acceptance of responses has been cut off following the transmission of a notification of the party to the participants, decides the date, time, and eating and drinking establishment at which the party will be held. Furthermore, this is a means whereby reservations for the party are transmitted to the eating and drinking establishment in cases in which instructions for the reservations for the party at the decided date, time, and eating and drinking establishment at which the party will be held are transmitted from the organizer terminal 2 so that these instructions are received by the party information registration means 5, and are stored in the party information storage means 6 (i.e., in cases in which the date, time, and eating and drinking establishment of the party are decided). For example, this is a means whereby an email describing the time and date of the party and the number of participants is transmitted to the eating and drinking establishment, so that party reservations can be made. When the party reservations are completed, an indication that these reservations have been completed is stored in the party information storage means 6.

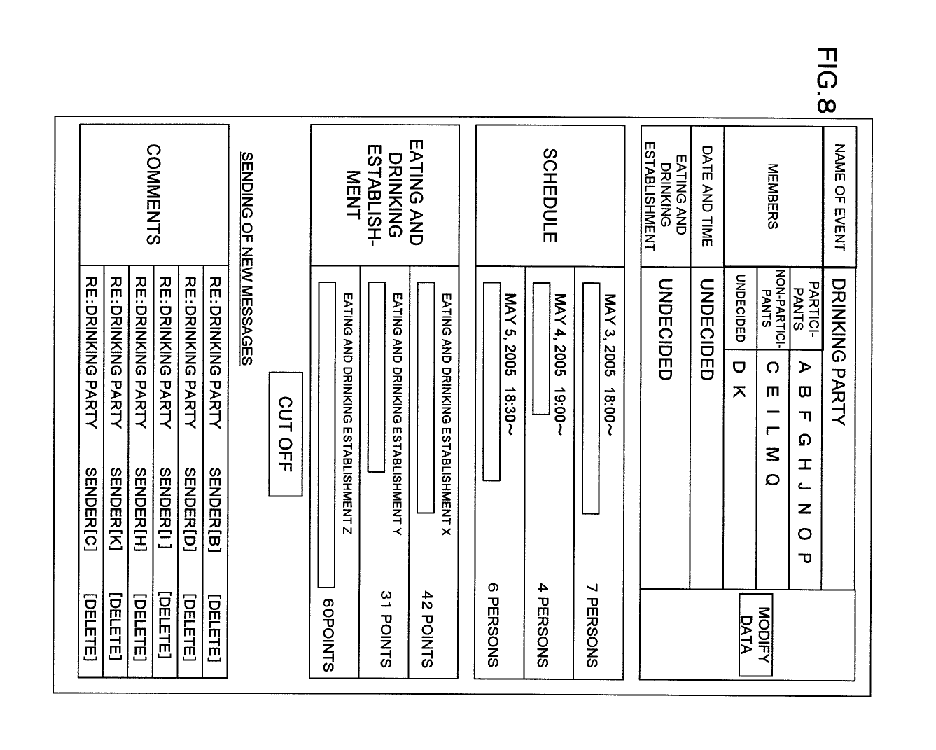

In the first reservation means 10, when the date and time of the party have been decided upon by the organizer (when instructions for reservations for the party have been stored in the party information storage means 6), participants who selected the decided schedule may be designated as “attendees,” participants who selected a schedule other than the decided schedule may be designated as “absentees,” and persons who have not responded may be designated as “undecided persons.” Then, information relating to these attendees and absentees is stored in the party information storage means 6. Then, when the first reservation means 10 transmits the reservations for the party with a specified timing to the eating and drinking establishment receiving from the organizer terminal 2, the number of persons designated as “attendees” stored in the party information storage means 6 is extracted as the number of participants and transmitted. One example of the screen used in cases in which the attendees, absentees, and undecided persons are thus automatically determined is shown in FIG. 8.

Furthermore, since the participants designated as “undecided persons” have not yet replied, reminding means (not shown in the figures) may be provided for urging these participants to reply with a specified timing.

It may also be envisioned that after the schedule has been decided upon, participants who were attendees may become absentees, participants who were absentees may become attendees, or participants who were undecided persons may become attendees or absentees. Accordingly, a button which can be used to modify data may be provided on the screen shown in FIG. 8, and the system may be devised so that information relating to attendees, absentees, and undecided persons among the participants can be altered by pressing this button on the organizer terminal 2. Here, the altered information is transmitted to the party reservation support system 1 from the organizer terminal 2, and is stored in the party information storage means 6.

The second reservation means 11 is a means whereby the organizer that has inspected the totaled responses from the respective participants after the acceptance of responses has been cut off following the transmission of a notification to the party participants determines the time and date and the eating and drinking establishment at which the party will be held. Then, in this means, instructions for party reservations at the decided party date, time, and eating and drinking establishment are transmitted from the organizer terminal 2, whereby these instructions are received by the party information registration means 5, and are stored in the party information storage means 6. In such cases, (i.e., in cases in which the time and date and the eating and drinking establishment of the party have been determined), the party time and date, the eating and drinking establishment, and the number of participants are sent in a notification to a predetermined contact (contact person) rather than a notification of reservations being sent directly to the eating and drinking establishment as in the case of the reservations made by the first reservation means 10. This contact person receives this notification and makes reservations by contacting the eating and drinking establishment. Thus, since the organizer does not make reservations directly, but instead uses a contact person, there is no need for the organizer to personally make reservations. When the reservations have been completed, an indication that the reservations have been completed is stored in the party information storage means 6.

In the second reservation means 11, as in the first reservation means 10, when the organizer has determined the date and time of the party (i.e., in cases in which indication of the party reservations has been stored in the party information storage means 6), participants who have selected the decided schedule may be designated as “attendees,” participants who have selected a schedule other than the decided schedule may be designated as “absentees,” and participants who have not responded may be designated as “undecided persons.” Then, the information relating to these attendees and absentees is stored in the party information storage means 6. Furthermore, the second reservation means 11 transmits the party reservations with a specified timing to the eating and drinking establishment received from the organizer terminal 2, whereupon the number of persons designated as “attendees” stored in the party information storage means 6 is extracted and transmitted as the number of participants. One example of the screen used in cases in which the attendees, absentees, and undecided persons are thus automatically determined is shown in FIG. 8.

When the reservations have been completed by the first reservation means 10 or second reservation means 11, the decision transmitting means 12 retrieves the email addresses for the party participants that are stored in the participant information storage means 7. Furthermore, in this means, map information for the eating and drinking establishment is retrieved from the map information storage means 13 on the basis of information relating to the eating and drinking establishment at which the party will be held, and the decided party date and time, the eating and drinking establishment, and the map information are transmitted to the email addresses of the respective participants.

The map information storage means 13 is a means for storing map information for respective eating and drinking establishments.

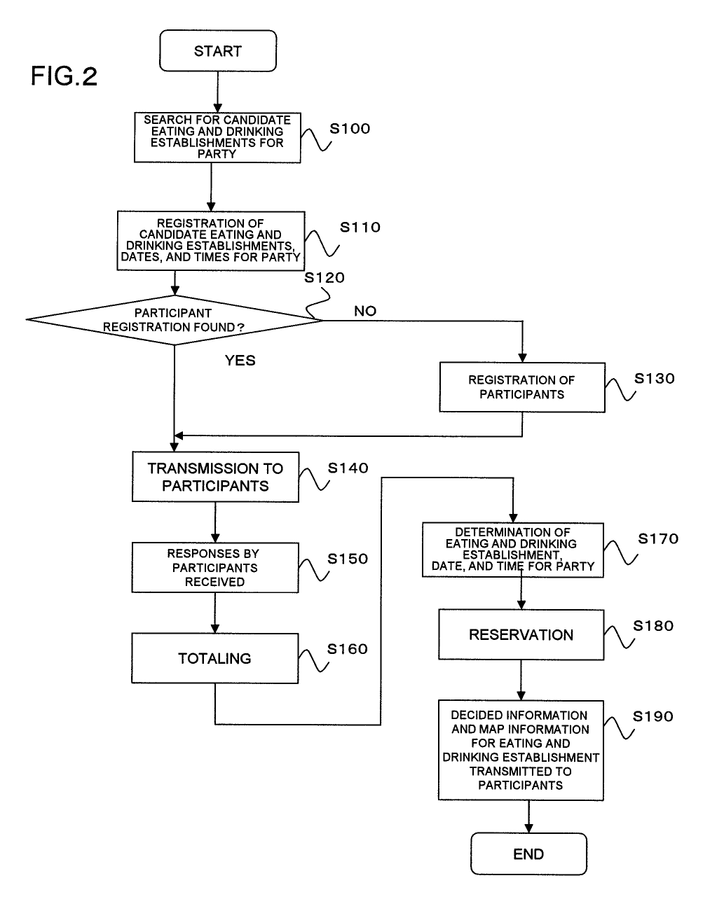

Next, one example of the process of the party reservation support system 1 of the present invention will be described with reference to the flowchart shown in FIG. 2 and the system configuration diagram shown in FIG. 1.

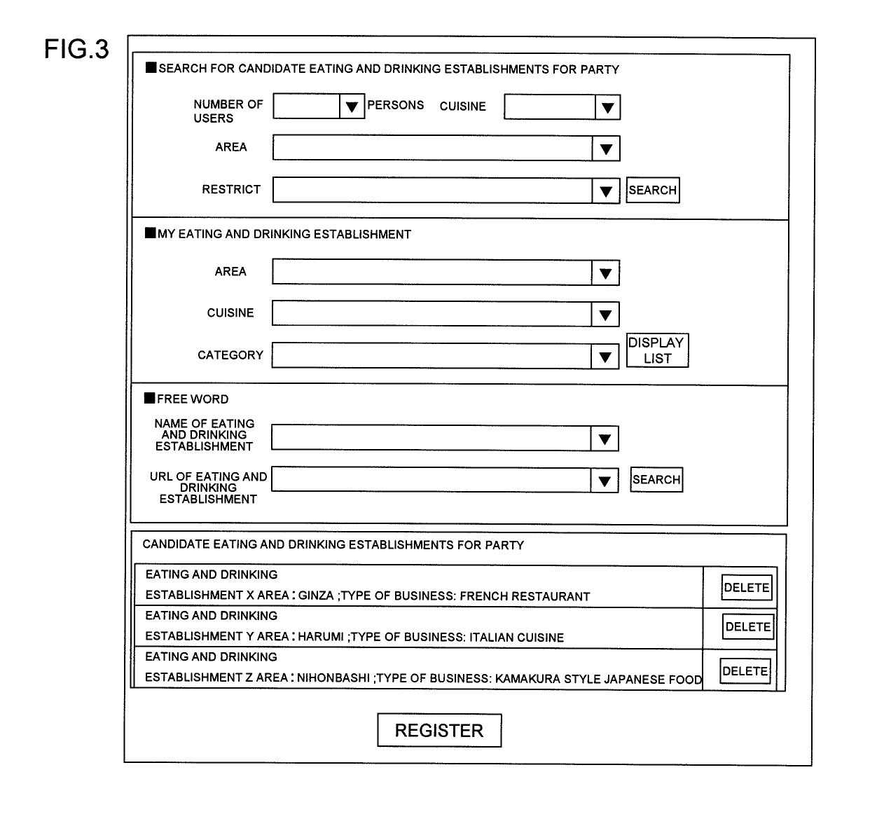

Using a specified method, the person who is the organizer for eating and drinking establishments accesses a computer terminal (including a server) that executes the party reservation support system 1, and opens a screen that searches for candidate eating and drinking establishments for the party according to a specified method. One example of this search screen is shown in FIG. 3.

When the search screen shown in FIG. 3 is received by the organizer terminal 2, the conditions of the party that is to be held, e.g., the number of users (number of envisioned participants), type of cuisine, area (region and location) of the eating and drinking establishment, and the like are entered as conditions. As a result of this information being received by the eating and drinking establishment information search means 3, the eating and drinking establishment information search means 3 searches the eating and drinking establishment information storage means 4 for eating and drinking establishments that satisfy these conditions, and transmits the results to the organizer terminal 2 (S100). The organizer inspects these results, and in cases in which there is an eating and drinking establishment that constitutes the best candidate, the organizer performs a specified operation, so that registration as a candidate is selected. Information indicating that an eating and drinking establishment has been registered as a candidate is transmitted from the organizer terminal, and is received by the party information registration means, so that this information is stored in the party information storage means 6 as information relating to this candidate eating and drinking establishment for the party. As a result of this storage, as is indicated at the bottom of the screen shown in FIG. 3, this eating and drinking establishment can be inspected as an eating and drinking establishment that is a candidate for the party.

Furthermore, as was described above, it is possible to devise the system so that a search is not performed on the basis of the party conditions from all of the eating and drinking establishments stored in the eating and drinking establishment information storage means, but a search is performed instead from among the eating and drinking establishments that are registered beforehand by the organizer as eating and drinking establishments that are to their liking, and so that these eating and drinking establishments are registered as candidates. Specifically, the system can be devised so that information is retrieved relating to eating and drinking establishments that are to the liking of the organizer, which is stored beforehand in a specified storage means of the party reservation support system 1, the eating and drinking establishment information search means 3 searches for eating and drinking establishments that satisfy the party conditions received from the organizer terminal 2 from among these retrieved eating and drinking establishments, and the search results are transmitted to the organizer terminal 2. In this case, the system can be devised so that information identifying the organizer is entered beforehand, and the organizer is identified on the basis of this identifying information, whereby information relating to eating and drinking establishments that are to the liking of the organizer, which has been registered by the organizer in advance, is retrieved from a specified storage means. Furthermore, in such a search operation, conditions such as areas, cuisine, and categories can be entered from “My Eating and drinking establishment” shown in FIG. 3.

The system may also be devised so that a search is made not on the basis of party conditions such as the number of users and the like, but rather so that the name of the eating and drinking establishment, URL of the eating and drinking establishment, and the like are received as search conditions, and the eating and drinking establishment information storage means 4 is searched on the basis of these conditions. Here, conditions can be entered from the section titled “Free Word” shown in FIG. 3.

After the organizer has registered a plurality of candidate eating and drinking establishments in this way, information relating to candidate dates and times for the party is transmitted to the party reservation support system 1 from the organizer terminal 2, and when this information is received by the party information registration means 5, information relating to the candidate dates and times for the party is stored in the party information storage means 6 (S110).

When respective candidate dates and times and eating and drinking establishments for the party have been determined, the organizer stores the names, email addresses, and the like of the participants in the participant information storage means 7 in cases in which information relating to the participants has not been registered (S130).

Following the registration in S130, or in cases in which registration has already been performed, the organizer selects the party participants, and transmits a notification of the candidate dates and times for holding the party stored in the party information storage means 6, as well as the candidate eating and drinking establishments found by the eating and drinking establishment information search means 3, to the respective participants (S140).

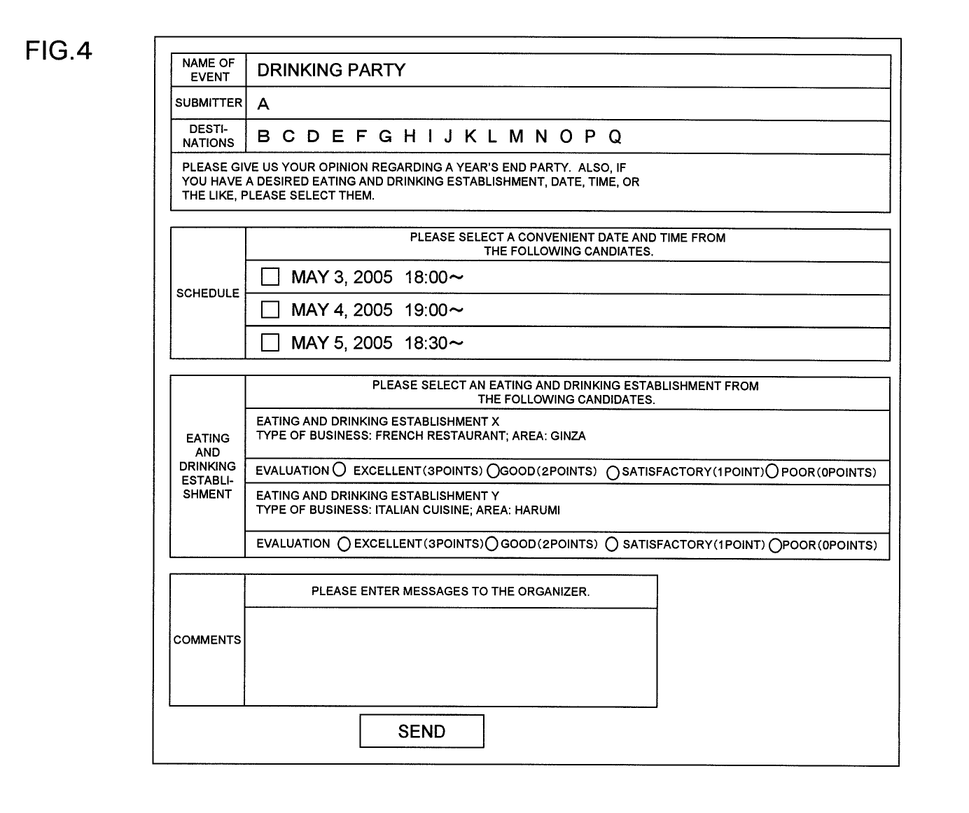

In concrete terms, when the participants are selected by the organizer performing a specified operation at the organizer terminal 2, the to-participant transmission means 8 retrieves the email addresses of the selected participants from the participant information storage means 7, and retrieves information relating to the party from the party information storage means 6. Then, emails containing party information are automatically prepared for the respective participants as shown in FIG. 4, and these are transmitted to the retrieved email addresses. It is desirable that this notification allow a schedule selection by the participants, and that a section be provided for entering objective evaluations of the eating and drinking establishments. In FIG. 4, objective evaluations of eating and drinking establishment are divided into four grades, i.e., “excellent,” “good,” “satisfactory,” and “poor,” and point scores are assigned to the respective grades, whereby these point scores constitute evaluations of the eating and drinking establishments by the participants. Accordingly, by totaling these evaluations, it is possible for the organizer to judge which impression regarding an eating and drinking establishment is best from an objective standpoint. In other words, if an eating and drinking establishment having a high eating and drinking establishment evaluation is selected, it is understood that the participant has evaluated this eating and drinking establishment in a positive manner, while if the evaluation is low (if there is no great difference from other candidate eating and drinking establishments) in spite of the fact that this eating and drinking establishment was the number one choice, it is understood that this is the result of a negative selection by the participant.

The participants who have received the notification transmitted from the party reservation support system 1 by the organizer in S140 inspect this notification, enter a date and time that are not inconvenient to themselves (if there is a convenient date among the candidates, this may of course be selected), and add an evaluation of the candidate eating and drinking establishments. The information in these responses is transmitted to the party reservation support system 1 from the respective participant terminals 14, and is received by the totaling means 9 (S150).

The totaling means 9 stores the information in the responses received from the respective participant terminals 14 in the party information storage means 6, and thus totals this information (S160). In other words, in regard to the date and time, 1 is added to the number of persons approving the date and time selected by the participants, and in regard to the objective evaluation of the eating and drinking establishment, the evaluation (point score) is added for each eating and drinking establishment, and is stored in the party information storage means 6. Furthermore, in cases in which there are comments, these comments are also stored in the party information storage means 6. Moreover, in regard to the number of approving persons and the evaluations, it is advisable to store information indicating who approved of which date and time, and what kind of evaluation was made regarding the eating and drinking establishments.

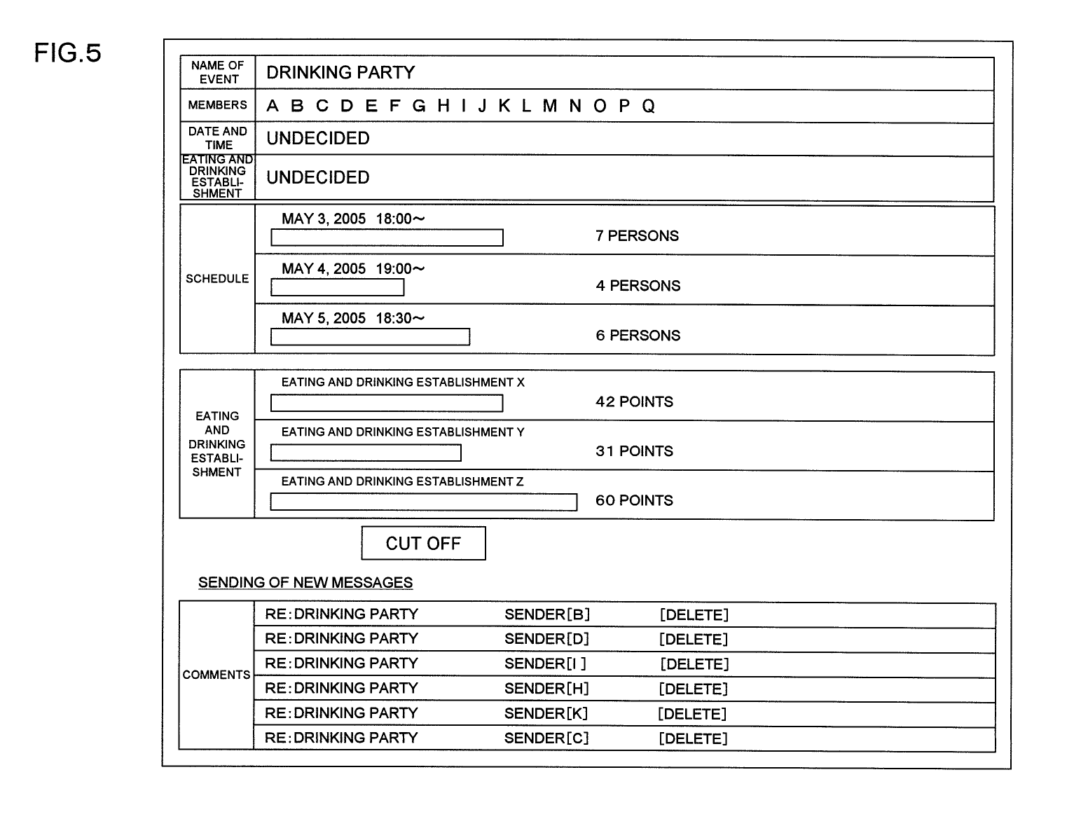

By performing a specified operation, the party organizer and participants can inspect an intermediate process (or results) in the discussion of the party as shown in FIG. 5. In this evaluation, understanding is facilitated if is displayed in a graph format as indicated in FIG. 5.

Furthermore, the reminding means (not shown in the drawings) may be configured so as to urging a response with a specified timing to participants who have not responded even though a specified time has elapsed. In this case, the email addresses of participants who still have not replied among the participants to whom an email was transmitted in S140 are again retrieved from the participant information storage means 7, and can be accomplished by transmitting an email containing a message urging a reply.

Observing a specified timing, the organizer cuts off the responses of the participants to the notification transmitted in S140. For example, as a result of the “cut off” button being pressed from the screen shown in FIG. 5, the storage of responses to the notification in the party information storage means 6 by the totaling means 9 is subsequently stopped.

Following this cut-off, the organizer inspects the totaled results and determines the date, time, and eating and drinking establishment at which the party will be held. Ideally, it is preferable to select the date and time for which the greatest preference was shown, and the eating and drinking establishment that received the highest evaluation. However, for example, in cases in which there are “main” participants, preference may also be given to the wishes of these participants. Here, for example, by selecting the number of persons for the date and time, and the point score of the eating and drinking establishment, it is possible to retrieve the participants selecting this date and time, as well as the objective evaluations for the eating and drinking establishment entered by the respective participants, and a judgment can be made by transmitting these to the organizer terminal 2 for inspection.

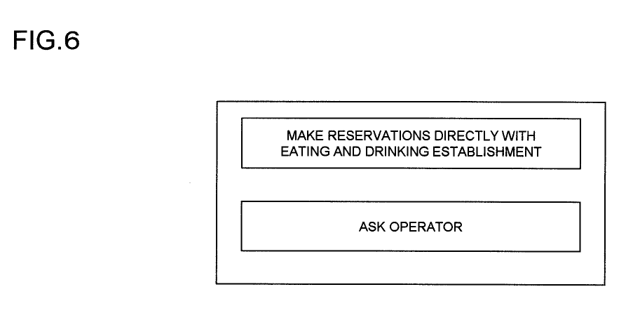

The organizer that has inspected the totaled responses from the respective participants determines the date, time, and eating and drinking establishment of the party. Then, the first reservation means 10 transmits the party reservations to the eating and drinking establishment in cases in which instructions to make party reservations for the decided date, time, and eating and drinking establishment of the party are transmitted from the organizer terminal 2, and these instructions are received by the party information registration means 5 and stored in the party information storage means 6 (i.e., in cases in which the date, time, and eating and drinking establishment are determined) (S180). These party reservations can be made by pressing “make reservations directly with the eating and drinking establishment” from the screen for making party reservations shown in FIG. 6, whereby the email address for the eating and drinking establishment is retrieved by the first reservation means 10 from the eating and drinking establishment information storage means 4, and by transmitting an email describing the date and time of the party and the number of participants to this email address. Furthermore, the date and time of the party and the number of participants may also be automatically entered on the basis of information relating to the decided date and time of the party and the number of participants stored in the party information storage means 6. When the reservations have been completed, an indication that the reservations have been completed is stored in the party information storage means 6.

In order to enter the number of participants automatically, in cases in which the date and time of the party have been determined, the first reservation means 10 can accomplish this by designating participants who have selected the decided schedule as “attendees,” designating participants who have selected a schedule other than the decided schedule as “absentees,” and designating participants who have not replied as “undecided persons.” Then, this information relating to attendees and absentees is stored in the party information storage means 6. Furthermore, when the first reservation means 10 transmits reservations for the party with a specified timing to the eating and drinking establishment received from the organizer terminal 2, the number of persons designated as “attendees” stored in the party information storage means 6 is extracted and transmitted as the number of participants.

As was described above, it is also possible to make reservations via a contact person rather than making reservations directly with the eating and drinking establishment. In this case, the organizer who has inspected the totaled responses from the respective participants decides the date, time, and eating and drinking establishment at which the party will be held. Then, the instructions to make party reservations at the date, time, and eating and drinking establishment that have been decided for the party are transmitted from the organizer terminal 2, whereby these instructions are received by the party information registration means 5 and stored in the party information storage means 6. In this case (i.e., in a case in which the date, time, and eating and drinking establishment for the party are decided), the second reservation means 11 sends a notification of the date, time, eating and drinking establishment, and number of party participants to a predetermined contact person, and transmits an email indicating the desired reservations, so that the party reservations are transmitted (S180). These party reservations can be made by pressing “ask operator” from the screen used to make reservations shown in FIG. 6, so that an email describing the date and time of the party and the number of participants is transmitted to the email address of the predetermined contact person (operator). As a result of receiving this notification, the contact person makes reservations for the party by contacting the eating and drinking establishment. Thus, since a contact person is provided rather than making reservations directly, there is no longer any need for the organizer to personally make reservations. When the reservations have been completed, an indication that the reservations have been completed is stored in the party information storage means 6.

Furthermore, besides making reservations by email in this way, it would also be possible for the organizer to make reservations by calling directly to the telephone number of the eating and drinking establishment.

As in the case of the first reservation means 10, in order to enter the number of participants directly, in cases in which the date and time of the party have been determined, the second reservation means 11 can accomplish this by designating participants who have selected the decided schedule as “attendees,” designating participants who have selected a schedule other than the decided schedule as “absentees,” and designating participants who have not replied as “undecided persons.” Furthermore, information relating to these attendees and absentees among the participants is stored in the party information storage means 6. Then, when the second reservation means 11 transmits reservations for the party at a specified timing to the eating and drinking establishment receiving from the organizer terminal 2, the number of persons designated as “attendees” stored in the party information storage means 6 is extracted and transmitted as the number of participants.

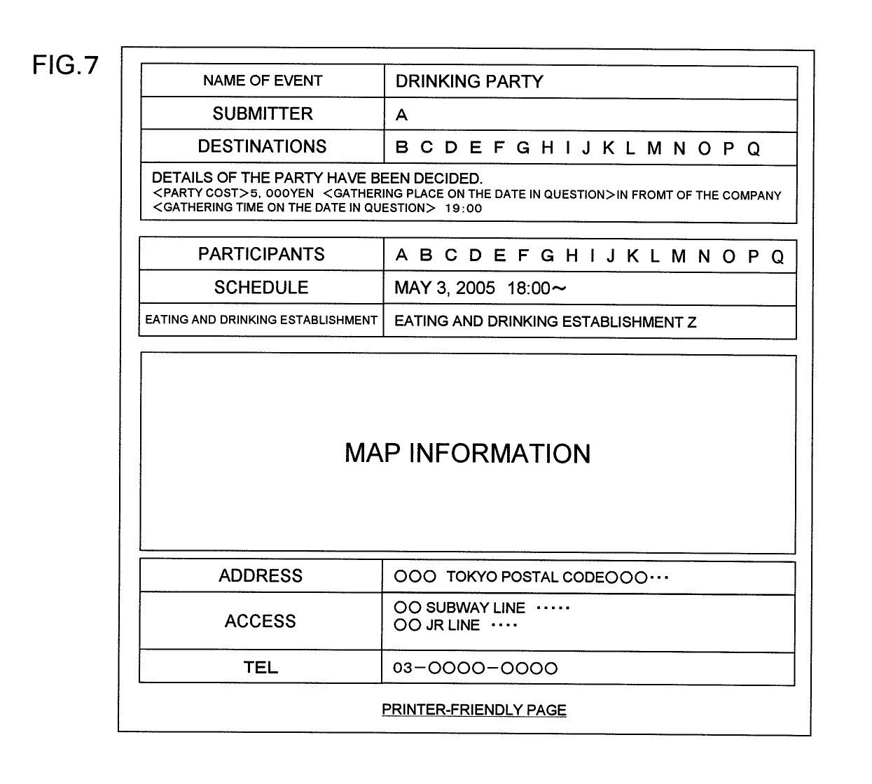

When the reservations have been completed by the first reservation means 10 or second reservation means 11, the decision transmitting means 12 retrieves the email addresses of the party participants that are stored in the participant information storage means 7. Furthermore, map information for the eating and drinking establishment is retrieved from the map information storage means 13 on the basis of information relating to the eating and drinking establishment at which the party will be held, and the decided party date, time, eating and drinking establishment, and map information are transmitted to the email addresses of the respective participants (S190). One example of the email that is transmitted here is shown in FIG. 7.

As a result of the above process being performed by the party reservation support system 1, conventional problems are solved, and a highly convenient system is realized.

When a notification of the party is transmitted to the respective participants in S140, a selection may be made by groups besides selecting the participants one at a time. By selecting such groups, it is possible to designate all of the members belonging to each group as participants.

In S110, the respective candidate dates, times, and eating and drinking establishments are discussed with the participants; however, it would also be possible to discuss only the dates and times, or only the eating and drinking establishments, with the participants. In this case, only the dates and times or the eating and drinking establishments that are the subject of discussion may be received as responses by the totaling means 9.

When the participants are registered in S130, the system may be configured so that new participants can be registered in a follow-up registration at an intermediate point in addition to the initial participants.

In other words, the organizer can use the organizer terminal 2 to enter the names, email addresses, and the like of new participants so that is stored in the participant information storage means 7. Following registration in S130, the organizer presents the participants with a notification that relates to the new party participants and includes the candidate dates and times for holding the party stored in the party information storage means 6, as well as the candidate eating and drinking establishment found by the eating and drinking establishment information search means 3.

In concrete terms, when new participants are selected by the organizer performing a specified operation at the organizer terminal 2, the to-participant transmission means 8 retrieves the email addresses of the selected new participants from the participant information storage means 7, and retrieves information relating to the party from the party information storage means 6. Then, an email containing party information for the respective participants as shown in FIG. 4 is automatically prepared, and this email is transmitted to the retrieved email addresses.

The follow-up registration of participants can also be accomplished by performing such processing.

The functions of the respective means in the present invention are merely distinguished in logical terms; in physical or actual terms, the same areas may be occupied.

### INDUSTRIAL APPLICABILITY

As a result of the adoption of the above configuration, eating and drinking establishments can be evaluated not only according to the criterion that “this eating and drinking establishment is good” as in conventional systems, but also according to an objective evaluation that “the impression of this eating and drinking establishment may be graded by the following point score”; accordingly, the organizer can grasp whether the participants have made a positive selection, or have made a selection for lack of an alternative (a selection in negative terms). Consequently, if the objective evaluation is low even though the eating and drinking establishment was most commonly selected by the participants, the organizer may judge that this is merely a selection in negative terms, and may propose other eating and drinking establishments as candidates.

Furthermore, since a configuration is adopted in which candidate dates and times selected beforehand by the organizer are transmitted, and the participants make a selection from these dates and times, there is an increased tendency for the participants to judge the date and time using the criterion of “a date that is not inconvenient” rather than “a date that is convenient.” As a result, the management of dates and times by the organizer is also facilitated.

In addition, in cases in which the reservation of a party has been determined, a notification with a map attached can be transmitted to the participants from the organizer; accordingly, this leads to an improvement in the convenience for the participants.

1. A party reservation support system comprising:
eating and drinking establishment information storage means for storing information relating to eating and drinking establishments;
party information storage means for storing information relating to candidate dates and times for the party, and information relating to candidate eating and drinking establishments for holding the party;
participant information storage means for storing attribute information for the party participants;
eating and drinking establishment information search means for receiving search conditions for said eating and drinking establishments from an organizer terminal used by the party organizer, retrieving information relating to eating and drinking establishments that satisfy said search conditions from said eating and drinking establishment information storage means, and transmitting to said organizer terminal;
party information registration means for receiving, from said organizer terminal, instructions for registering eating and drinking establishments selected from the eating and drinking establishments found by said search as candidates, and information relating to candidate dates and times for said party designating said selected eating and drinking establishments as candidate eating and drinking establishments for said party, and storing said candidate eating and drinking establishments and candidate dates and times in said party information storage means;
to-participant transmission means for retrieving the email addresses of participants designated as participants in said party from said participant information storage means, and transmitting an email, to said retrieved email addresses, describing said candidate, for the party, eating and drinking establishments and said candidate dates and times;
totaling means for receiving information relating to the party dates and times selected by said participants and information relating to objective evaluations for said candidate eating and drinking establishments as responses to said organizer from participant terminals used by said participants, and adding this information to the number of persons approving the candidate dates and times for said party in said party information storage means, and the objective evaluations for said eating and drinking establishments;
first reservation means for receiving information, from said organizer terminal, relating to the date, time, and eating and drinking establishment at which the party is to be held as decided by said organizer, after said responses have been cut off, retrieving the email address of the eating and drinking establishment that has been decided upon from said eating and drinking establishment information storage means, and transmitting an email making reservations for said party to said retrieved email address of the eating and drinking establishment; and
decision transmitting means for retrieving the email addresses of said party participants from said participant information storage means, and transmitting information relating to the date, time, and eating and drinking establishment decided for said party to said retrieved email addresses.

2. A party reservation support system comprising:
eating and drinking establishment information storage means for storing information relating to eating and drinking establishments;
party information storage means for storing information relating to candidate dates and times for holding a party, and information relating to candidate eating and drinking establishments at which the party may be held;
participant information storage means for storing attribute information relating to the party participants;
eating and drinking establishment information search means for receiving search conditions for said eating and drinking establishments from an organizer terminal used by said party organizer, retrieving information relating to eating and drinking establishments that satisfy said search conditions from said eating and drinking establishment information storage means, and transmitting this information to said organizer terminal;
party information registration means for, from said organizer terminal, receiving instructions for registering eating and drinking establishments, as candidates, selected from the eating and drinking establishments found by said search, and information relating to candidate dates and times for said party designating said selected eating and drinking establishments as candidate eating and drinking establishments for said party, and storing said candidate eating and drinking establishments and candidate dates and times in said party information storage means;
to-participant transmission means for retrieving, from said participant information storage means, the email addresses of participants designated as participants in said party, and transmitting, to said retrieved email addresses, an email describing said candidate eating and drinking establishments for the party and said candidate dates and times;
totaling means for receiving, from participant terminals used by said participants, as responses to said organizer, information relating to the dates and times of the party selected by said participants and information relating to objective evaluations for said candidate eating and drinking establishments, and adding this information, respectively, to the number of persons approving the candidate dates and times for said party and to the objective evaluations for said eating and drinking establishments in said party information storage means;
second reservation means for receiving, from said organizer terminal, information relating to the date and time of the party and the eating and drinking establishment decided by said organizer after stopping acceptance of said responses, and transmitting, to the email address of a predetermined contact person, an email making reservations for said party; and
decision transmitting means for retrieving, from said participant information storage means, the email addresses of said party participants, and transmitting, to said retrieved email addresses, information relating to the date, time, and eating and drinking establishment that have been decided upon for the party.

3. The party reservation support system according to claim 1, characterized in that said totaling means transmits intermediate processes and/or results of said responses in a graph format to said organizer terminal and said participant terminals.

4. The party reservation support system according to claim 3, characterized in that said party reservation support system further has map information storage means for storing map information relating to the vicinity of said eating and drinking establishments, and said decision transmitting means attaches and transmits the map information relating to the vicinity of the eating and drinking establishments to the email addresses used for transmissions to said participants.

5. The party reservation support system according to claim 4, characterized in that said participant information storage means further stores a plurality of participants as one group, and when said group is selected as participants, said to-participant transmission means and said decision transmitting means retrieve, from said participant information storage means, the email addresses of participants belonging to said group, and transmit emails.

6. The party reservation support system according to claim 5, characterized in that said party reservation support system further comprises first reservation means for receiving, from said organizer terminal, information relating to the party date, time, and eating and drinking establishment decided by said organizer after stopping acceptance of said responses, retrieving, from said eating and drinking establishment information storage means, the email address of said determined eating and drinking establishment, and transmitting, to said retrieved email address of the eating and drinking establishment, an email making reservations, wherein
a screen for selecting a method by which reservations are made, the method including said first reservation means and said second reservation means, is transmitted to said organizer terminal, and the selection results are received from said organizer terminal, whereby said email for making reservations for the party is transmitted by the first reservation means or second reservation means using the selected reservation method.

7. The party reservation support system according to claim 1, characterized in that said first reservation means, when information relating to the date and time of the party decided by said organizer is received from said organizer terminal, designates as attendees those participants who have selected said decided date and time, designates as absentees those participants who have selected a date and time other than the decided date and time are designated, and stores in said party information reservation means, and transmits, when it transmits an email making reservations for said party is transmitted to the email address of said eating and drinking establishment that has been decided upon, an email in which said number of persons designated as attendees is described as the number of participants to the same.

8. The party reservation support system according to claim 2, characterized in that said second reservation means, when information relating to the date and time of the party decided by said organizer is received from said organizer terminal, designates as attendees the participants who have selected said decided date and time, designates as absentees those participants who have selected a date and time other than the decided date and time, and stores in said party information reservation means, and transmits, when it transmits an email making reservations for said party to the email address of said contact person, an email in which said number of persons designated as attendees is described as the number of participants to the same.

9. The party reservation support system according to claim 1, characterized in that said party reservation support system further comprises reminding means for transmitting, when said totaling means does not receive, after a specified time has elapsed, a response to the email transmitted to the email addresses of the respective participants by said to-participant transmission means, an email urging said participants, from whom no response has been received, to respond.

10. The party reservation support system according to claim 2, characterized in that said totaling means transmits intermediate processes and/or results of said responses in a graph format to said organizer terminal and said participant terminals.

11. The party reservation support system according to claim 10, characterized in that said party reservation support system further has map information storage means for storing map information relating to the vicinity of said eating and drinking establishments, and said decision transmitting means attaches and transmits the map information relating to the vicinity of the eating and drinking establishments to the email addresses used for transmissions to said participants.

12. The party reservation support system according to claim 11, characterized in that said participant information storage means further stores a plurality of participants as one group, and when said group is selected as participants, said to-participant transmission means and said decision transmitting means retrieve, from said participant information storage means, the email addresses of participants belonging to said group, and transmit emails.

13. The party reservation support system according to claim 12, characterized in that said party reservation support system further comprises first reservation means for receiving, from said organizer terminal, information relating to the party date, time, and eating and drinking establishment decided by said organizer after stopping acceptance of said responses, retrieving, from said eating and drinking establishment information storage means, the email address of said determined eating and drinking establishment, and transmitting, to said retrieved email address of the eating and drinking establishment, an email making reservations, wherein
a screen for selecting a method by which reservations are made, the method including said first reservation means and said second reservation means, is transmitted to said organizer terminal, and the selection results are received from said organizer terminal, whereby said email for making reservations for the party is transmitted by the first reservation means or second reservation means using the selected reservation method.

14. The party reservation support system according to claim 2, characterized in that said party reservation support system further comprises reminding means for transmitting, when said totaling means does not receive, after a specified time has elapsed, a response to the email transmitted to the email addresses of the respective participants by said to-participant transmission means, an email urging said participants, from whom no response has been received, to respond.
